(19) United States
(12) Patent Application Publication
(10) Pub. No.: US 2026/0194641 A1
(43) Pub. Date: Jul. 9, 2026

(54) DEPLOYABLE TRUSS SYSTEM

(71) Applicant: Ultra Electronics Maritime Systems, Inc., Columbia City, IN (US)

(72) Inventors: Justin Lawrence Kendall, Lunenburg, Nova Scotia (CA); Christopher Francis Brake, Dartmouth, Nova Scotia (CA); Gary Wang, Hammonds Plains, Nova Scotia (CA); Andrew George Anderson, London (GB); Adam Charles Gray, Victoria, British Columbia (CA)

(21) Appl. No.: 19/431,584

(22) Filed: Dec. 23, 2025

Related U.S. Application Data
(63) Continuation of application No. PCT/US2025/050265, filed on Oct. 9, 2025.
(60) Provisional application No. 63/706,379, filed on Oct. 11, 2024.

(51) Int. Cl. E02B 17/00

(52) U.S. Cl. CPC E02B 17/00

(57) ABSTRACT

A deployable truss may include multiple longerons connected together by battens and diagonals, the longerons resiliently deformable to form a coil when the truss is collapsed; and a leading end configured to move to deploy the truss, wherein, during deployment from a collapsed configuration, the coil moves to deploy the truss. A deployment system may apply a torsional load to the coil to cause formation of a stiff or rigid truss section from the coil. An orientation control system may control a position of the truss, such as adjusting the truss's orientation or tilt, within a water column. A storage sleeve may receive the coil when the truss is collapsed. Multiple sensors may be coupled to the truss in a sensor spacing allowing formation of the coil without geometric interference of the sensors.

### CROSS-REFERENCE TO RELATED APPLICATIONS

The present application is a continuation of PCT International Patent Application No. PCT/US2025/050265, filed Oct. 9, 2025, which claims the benefit of and priority to U.S. Provisional Patent Application No. 63/706,379, filed Oct. 11, 2024, both of which are incorporated by reference herein in their entireties.

### FIELD

The present application relates to extendible truss structures, such as a deployable truss system used in underwater applications.

### BACKGROUND

Deployable structures have generally been linearly deployed systems extending from a fixed base. Portions of the deployable structures may collapse or fold, such as to reduce the stowed volume of the structure. When deployed, the extendible structures may form a vertical mast, such as to form an antenna support or other vertical structure. Designing a deployable horizontal support can be difficult, especially when the deployable structure is lightweight and placed in a long, cantilevered position or configuration. Some deployable structures have been designed for space applications, taking advantage of limited air resistance and other external forces.

Therefore, a need exists for systems and methods that addresses the concerns above or at least offers an alternative to existing solutions.

### BRIEF SUMMARY

In one example, a truss for deployment within a water column includes a plurality of longerons connected together by a plurality of battens and a plurality of diagonals, the longerons resiliently deformable to form a coil when the truss is collapsed into a collapsed configuration. The truss further includes a stationary end, and a leading end configured to move away from the stationary end. During deployment of the truss from the collapsed configuration, the coil sits at one of the stationary end or the leading end and a stiff truss section is ejected from the coil.

Optionally, during deployment of the truss from the collapsed configuration, the coil sits at the leading end and moves away from the stationary end with the leading end to eject the stiff truss section in the wake of the coil.

Optionally, during deployment of the truss from the collapsed configuration, the coil sits at the stationary end and rotates to eject the stiff truss section as the leading end.

Optionally, at least one longeron of the plurality of longerons includes multiple rods coupled together. Each longeron of the plurality of longerons may include four rods.

Optionally, the truss includes a deployment/retraction line, wherein the truss is configured to collapse into the coil when the deployment/retraction line is pulled. The deployment/retraction line may be shorter than a length of the truss. The truss may include a spring system configured to bias the truss to coil in a specific direction.

Optionally, the truss includes a first structure at the stationary end, a second structure at the leading end, and at least one deployment/retraction line extending between the first structure and the second structure to control an axial speed of deployment or retraction of the coil. The at least one deployment/retraction line may be configured to sync a rotation of the coil with a deployment/recovery speed of the coil.

Optionally, the truss includes positively buoyant items positioned on an upper apex of the truss, and negatively buoyant items positioned on lower longerons of the truss.

Optionally, the battens are bowed into a direction of current flow in the water column. The battens may include a helical wrap or streamers attached thereto.

Optionally, the truss includes a plurality of bays connected together in series to define a length of the truss. Each bay may include one or more diagonals extending along each side of the truss. The one or more diagonals along each side of the truss may be connected by an attachment at an intersection of the diagonals. A string or cord may extend to define each diagonal of a respective bay.

Optionally, the truss includes a deployment system coupled to the leading end and configured to drive deployment of the truss, wherein the deployment system is configured to apply a torsional load to the coil to cause formation of the truss section from the coil.

Optionally, the collapsed configuration creates elastic stored energy in the coil, wherein the elastic stored energy is configured to self-deploy the truss from the collapsed configuration.

Optionally, the truss is configured to deploy in a vertical orientation using a combination of gravity, buoyancy, and drag.

Optionally, the truss includes an orientation control system configured to control an orientation of the truss, wherein the orientation control system is configured to adjust a vertical position of the truss within the water column

In another example, a deployable truss includes a plurality of longerons held together by a plurality of battens and a plurality of diagonals, the longerons resiliently deformable to form a coil in a collapsed configuration. The deployable truss further includes a leading end, the coil sitting at the leading end and configured to move with the leading end to deploy the truss. The deployable truss further includes a deployment system coupled to the leading end and configured to drive deployment of the truss, wherein the deployment system is configured to apply a torsional load to the coil to cause formation of a rigid truss section in the wake of the leading coil.

Optionally, the deployment system includes an inertial system and a drive system configured to rotate the leading end to uncoil the coil. The inertial system may include a float and a weighted section, wherein the inertial system is connected to the drive system at a portion between the float and the weighted section.

Optionally, the deployment system includes at least one thruster coupled to the leading end, the least one thruster configured to induce a torsion to rotate the leading end to uncoil the coil. The at least one thruster may be configured to apply an axial load to extend the truss.

In another example, a truss for deployment within a water column includes a collapsible structure including a stationary end and a free end. The truss further includes an orientation control system configured to adjust a position of the truss within the water column, wherein the orientation control system is configured to control a vertical position of the free end relative to the stationary end.

Optionally, the orientation control system includes one or more thrusters configured to induce a force at the free end to move the free end up or down the water column.

Optionally, the orientation control system includes a cable coupled to the free end, and wherein adjustment of the cable adjusts a vertical position of the free end within the water column.

Optionally, the orientation control system includes a sea anchor or parachute coupled to the free end.

Optionally, the orientation control system includes a buoyancy characteristic, wherein the buoyancy characteristic is adjustable prior to or during deployment of the truss.

In another example, a joint is provided for a deployable truss having a collapsible structure defined by a plurality of longerons held together by a plurality of battens and a plurality of diagonals, the joint connecting at least one batten and at least one diagonal to a longeron. The joint includes multiple parts manufactured or assembled together as a single unit. The multiple parts include a first part rotatably coupled to a second part.

Optionally, the first part is a hinge coupled to a pair of battens, the second part is configured to secure a pair of diagonals, and the multiple parts include a third part configured to receive rods defining the longerons.

Optionally, the joint includes a stop configured to limit a rotation of the first part relative to the second part. The stop may be defined on the second part.

Optionally, the first part rotates about a first axis, and the third part rotates about a second axis perpendicular to the first axis.

In another example, a system includes a first truss segment and a second truss segment, each truss segment comprising a collapsible structure comprising a plurality of longerons held together by a plurality of battens and a plurality of diagonals, the collapsible structure resiliently deformable to form a coil in a collapsed configuration. The system further includes a connection joint configured to selectively couple the longerons of the first truss segment to the longerons of the second truss segment.

Optionally, the first truss segment includes a first stiffness, wherein the second truss segment comprises a second stiffness different than the first stiffness. The first stiffness may be determined by a first number of rods per longeron or a first rod stiffness, and the second stiffness may be determined by a second number of rods per longeron or a second rod stiffness.

In another example, a system includes a truss including a collapsible structure defined by a plurality of longerons held together by a plurality of battens and a plurality of diagonals, the collapsible structure resiliently deformable to form a coil in a collapsed configuration. The system further includes a storage sleeve configured to receive the coil when the truss is collapsed.

Optionally, the storage sleeve includes a tubular body having an inside diameter configured to accommodate an outside diameter of the coil when collapsed. The tubular sleeve may include an open end, wherein guides are defined at the open end to ease insertion of the truss into the tubular body. The guides may be fixed or deployable.

In another example, a system includes one or more nodes, and a plurality of trusses in different orientations and connected to the one or more nodes to form a volumetric array structure, each truss of the plurality of trusses including a collapsible structure defined by a plurality of longerons held together by a plurality of battens and a plurality of diagonals, the collapsible structure resiliently deformable to form a coil in a collapsed configuration.

Optionally, the one or more nodes comprises a central node, wherein the plurality of trusses extend from the central node in different directions.

In another example, a system includes a truss including a collapsible structure defined by a plurality of longerons held together by a plurality of battens and a plurality of diagonals, the battens and diagonals connected to the longerons at joints, the collapsible structure resiliently deformable to form a coil in a collapsed configuration. The system further includes a plurality of sensors coupled to the truss in a sensor spacing, wherein the sensor spacing is configured to allow formation of the coil without geometric interference of the sensors.

Optionally, the sensors are connected to an outside diameter of the truss. The sensors may extend around the outside diameter of the truss. A connection of the sensors to the truss may limit a rotation of the sensors to an inner diameter of the coil.

Optionally, the sensors are positioned within the internal diameter of the truss. The sensors may stack against one another, face to face, when the truss is collapsed to form the coil.

Optionally, the system includes a cable management system around the exterior of the truss, the cable management system configured to limit positioning of one or more cables between adjacent coils of the coil in the collapsed configuration.

In another example, an underwater system includes a truss including a collapsible structure defined by a plurality of longerons held together by a plurality of battens and a plurality of diagonals. The underwater system further includes a plurality of sensors selectively deployable from the truss to define a planar array at a depth below the truss.

Optionally, the planar array includes a plurality of sensors in single line arrays distributed along a length of the truss. A single line array may include a top and a bottom, a float at the top, and a weight at the bottom The single line arrays may be retracted via selective coiling of a deployable line.

In addition to the exemplary aspects and embodiments described above, further aspects and embodiments will become apparent by reference to the drawings and by study of the following description.

### BRIEF DESCRIPTION OF THE DRAWINGS

FIG. 1 illustrates an example deployable truss in a partially deployed configuration.

FIGS. 2A-4 illustrate various examples of deployment assistance features for a deployable truss.

FIGS. 5-9 illustrate various examples of orientation control for deployment of a deployable truss.

FIGS. 10A-10B illustrate example longeron configurations of a deployable truss.

FIG. 11 illustrates an example bay of a deployable truss in an expanded configuration.

FIG. 12 illustrates an example connection of adjacent diagonals within a bay of a deployable truss.

FIG. 13 illustrates an example deployable truss in a collapsed configuration.

FIGS. 14A-14B illustrate example joints of a deployable truss.

FIGS. 15A-15B illustrate cross-sectional views of example joints of a deployable truss.

FIG. 16 illustrates an example connection joint for connecting separate truss units together.

FIGS. 17A-17B illustrate example batten configurations of a deployable truss for strum reduction.

FIG. 18 illustrates example storage features for a deployable truss system.

FIG. 19 illustrates an example sensor connection to a deployable truss.

FIG. 20 illustrates an example sensor spacing that facilitates coiling of a deployable truss.

FIG. 21 illustrates an example sensor configuration of a deployable truss.

FIG. 22 illustrates an example sensor array of a deployable truss.

FIG. 23 illustrates an example system for deploying a vertical line array of sensors from a deployable truss.

FIG. 24 illustrates an example volumetric array.

FIGS. 25A-25B illustrate an example cable management system.

FIGS. 26A-26B illustrate an example sensor or projector configuration of a deployable truss.

FIGS. 27A-27E illustrate another example sensor or projector configuration of a deployable truss.

### DETAILED DESCRIPTION

Embodiments will now be described with reference to the drawings. To facilitate description, reference numerals designating an element in one figure will represent the same element in any other figure.

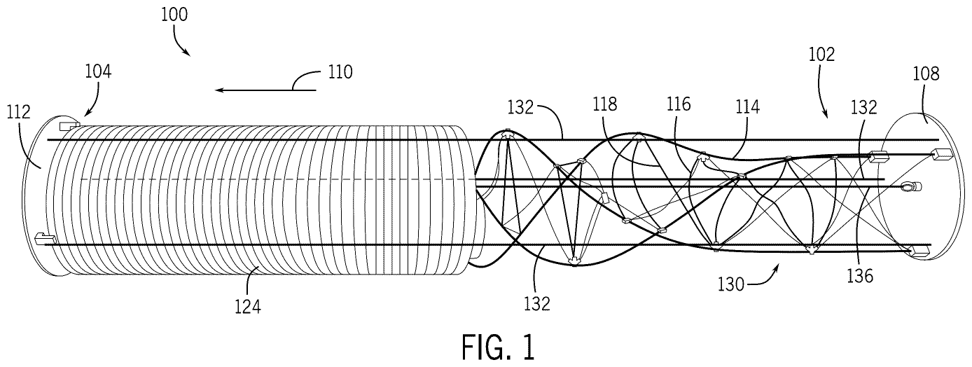

FIG. 1 illustrates an example deployable truss 100 (hereinafter “truss” for sake of convenience without intent to limit). The truss 100 is deformable to allow the truss 100 to transition between collapsed and expanded configurations. In the collapsed configuration, the truss 100 is coiled, manipulated, or otherwise collapsed in size (e.g., in length), such as to position the truss 100 for storage, transportation, repositioning, etc. In the expanded configuration, the truss 100 is uncoiled, unwound, or otherwise expanded in size (e.g., in length), such as to position or configure the truss 100 for use. Depending on the application, the truss 100 may define a vertical column or a horizontal beam, such as to support various components or accessories, define a support or structural framework, or the like, above ground, below ground, in space, in water, or elsewhere. Thus, the truss 100 may be oriented horizontally, vertically, or at any other orientation, based on application or system requirements. In one example, the truss 100 is designed for deployment below a water surface (within an ocean, sea, lake, or other fluid body), such as selectively deployed to position one or more underwater sensors, provide an underwater framework or structure, or the like, as described below.

The truss 100 may include a first end 102 and a second end 104. The first end 102 may be stationary, such as fixed or held in position underwater (e.g., secured to a fixed structure, held in position by an anchor, mooring, vehicle, or vessel, etc.). The first end 102 may include a first structure 108. The first structure 108 may include a plate, an annulus, or another structure. The second end 104 may move relative to the first end 102. For example, the second end 104 may move longitudinally away from the first end 102, such as along an axis defined by the truss 100 (e.g., the longitudinal axis of the truss 100) in a direction of deployment 110. The second end 104 may include a second structure 112. The second structure 112 may include a plate, an annulus, or another structure. The second structure 112 may be similar to or different than the first structure 108.

The truss 100 may include various configurations providing a desired rigidity or strength when expanded, while allowing the truss 100 to deform to collapse (e.g., for compactness). For instance, the truss 100 may include multiple longerons 114 (e.g., at least two longerons 114, three or more longerons 114, etc.) and multiple battens 116 and one or more diagonals 118 extending between the longerons 114. Each of the longerons 114, battens 116, and diagonals 118 may be resiliently deformable allowing the truss 100 to selectively collapse.

FIG. 1 illustrates the truss 100 in a partially deployed configuration. The truss 100 may deform along its length, such as between the first end 102 and the second end 104. In the example of FIG. 1, the truss 100 may coil or collapse on itself, such as to stack the truss 100 for compactness (e.g., defining a coil 124 or coil pack). In one example, the coil 124 or coiled end may move away from a stationary end of the truss 100 (e.g., the first end 102), such as to uncoil or expand the truss 100 (e.g., starting at the first end 102). For example, during deployment of the truss 100, the coil 124 may sit at a leading end (e.g., the second end 104) and move away from the stationary end with the leading end to eject a stiff or rigid truss section 130 in the wake of the coil 124. In another example, the coil 124 or coiled end may sit at a stationary end of the truss 100 (e.g., the second end 104), with the opposite end of the truss 100 moving away from the stationary end to uncoil or expand the truss 100. For example, during deployment of the truss 100, the coil 124 may sit at the stationary end and rotate to eject the truss section 130 as the leading end. In this manner, the first end 102 may be the stationary end or the leading end. Likewise, the second end 104 may be the stationary end or the leading end. The truss 100 may continue to uncoil or expand, with the coil 124 reducing in size until the truss 100 is fully expanded between the first end 102 and the second end 104. Once expanded or formed, the truss 100 may provide the desired rigidity or strength.

The configuration of the truss 100 may provide a controlled deployment. For example, the truss configuration may force the coil 124 to sit at the leading end or stationary end for deployment (e.g., the second end 104), while the truss section 130 emerges. Such configurations may limit entanglement with external features. The configurations may also eliminate or reduce risks of drag-based torsional buckling, such as by removing the need to rotate the deployed truss 100 (e.g., the truss 100 is formed as the coil 124 unwinds or rotates about the longitudinal axis, creating a stiff truss structure behind the coil 124 or away from the coil 124).

In examples, the truss 100 may include one or more external deployment/recovery lines 132. For instance, multiple external deployment/recovery lines 132 (e.g., 2-3 lines) may extend along the outside diameter of the coil 124, such as spaced equidistantly around the coil 124, although other configurations are contemplated. The external deployment/recovery lines 132 may control the axial speed of deployment or retraction of the truss 100 or coil 124. For example, the external deployment/recovery lines 132 may be configured to sync deployment/recovery speed with coil rotation, or vice versa (e.g., to ensure deployment/recovery speed is consistent with coil rotation, to ensure deployment/recovery speed does not outpace coil rotation, to allow sufficient coil rotation during deployment/recovery, etc.). Multiple external deployment/recovery lines 132 may be preferred over a single line. For example, a pivot point may develop between the coil 124 and the truss section 130 when a single external deployment/recovery line 132 is used. Multiple external deployment/recovery lines 132 may be attached at the outer radius of the truss 100 to control the orientation of the leading plate (e.g., the second structure 112). For example, the multiple external deployment/recovery lines 132 may control how parallel the plates are or remain during deployment and/or recovery (e.g., a parallel orientation of the first structure 108 to the second structure 112). In other examples, a rigid mount may be added from the leading plate that moves the connection to the external deployment line 132 to a point within the region of the deployed truss section 130.

In some examples, the truss 100 may include a central deployment/retraction line 136, whether in addition to or in place of the external deployment/recovery lines 132. The central deployment/retraction line 136 may control the axial speed of deployment or retraction of the truss 100 or coil 124. For example, the central deployment/retraction line 136 may be configured to sync deployment/recovery speed with coil rotation, or vice versa (e.g., to ensure deployment/recovery speed is consistent with coil rotation, to ensure deployment/recovery speed does not outpace coil rotation, to allow sufficient coil rotation during deployment/recovery, etc.). In examples, the central deployment/retraction line 136 may slow the natural uncoiling of the coil 124 or truss 100, such as to allow more stable deployment and limit buckling of the truss 100 during deployment. In examples, the central deployment/retraction line 136 may be shorter than the length of the extended truss 100, such as to limit complete truss deployment, facilitate recovery, or the like. The central deployment/retraction line 136 may extend along the center of the truss 100, such as along the longitudinal axis of the truss 100. The central deployment/retraction line 136 may be pulled to retract the deployed truss 100. For example, coiling may be initiated at the first end 102 (e.g., in the first bay of the truss 100), at the second end 104 (e.g., in the last bay of the truss 100), or at both ends simultaneously or near simultaneously as the central deployment/retraction line 136 is pulled. Continued retraction, such as to define coil 124, may occur with continued pulling of the central deployment/retraction line 136. In examples, truss stiffness may not be affected along portions of the truss 100 during retraction. For instance, a transition zone may be defined between the truss section 130 and the coil 124, the transition zone defining a continuously changing 2-3 bay length of the truss 100 that deforms for coiling. In such examples, the truss stiffness in the truss section 130 is not affected outside of the transition zone. These features may also avoid the need to torsionally buckle the truss 100 via external means.

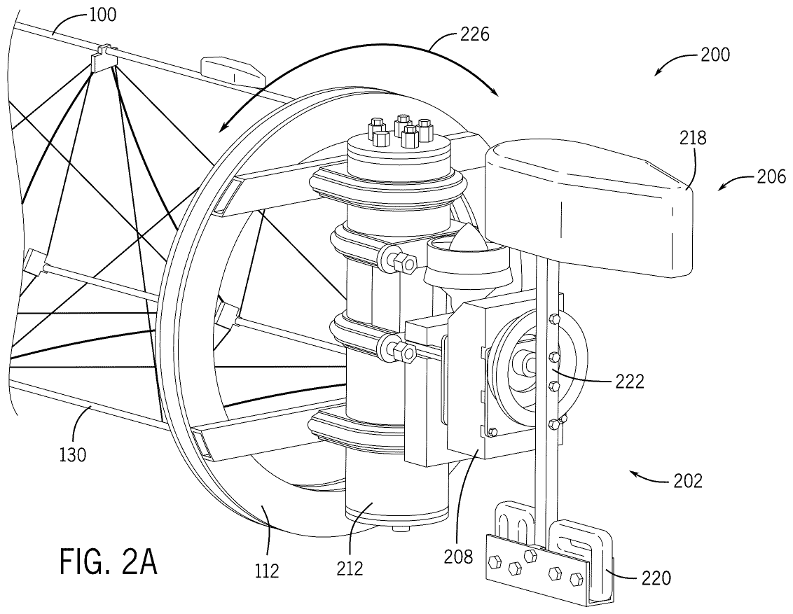

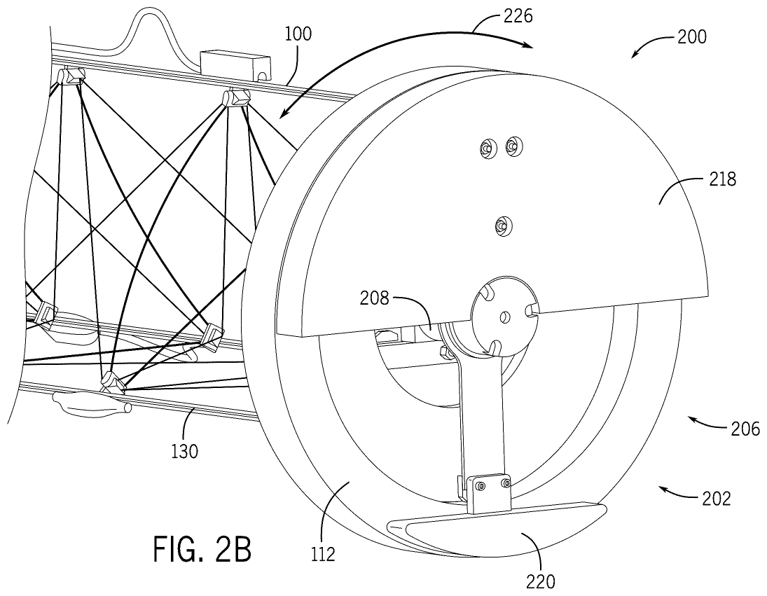

FIGS. 2A-4 illustrate various examples of a deployment system 200 having one or more assistance features for deploying the truss 100. When embodied as an underwater system, deployment of the truss 100 may be aided by fluid flow, such as when fluid flow aligns with the direction of deployment 110. In the absence of fluid flow, or when fluid flow at least partially counteracts the direction of deployment 110, controlled deployment of the truss 100 may be limited. In such examples, the truss 100 may include one or more deployment assistance features to facilitate the controlled deployment and/or retraction of the truss 100.

As one example, FIGS. 2A-2B illustrate the deployment system 200 as a torsion system 202. To facilitate deployment, the torsion system 202 applies a torsional load to the truss 100, ejecting the truss section 130 (e.g., in the wake of the leading coil 124, as the leading end, etc.). The torsion system 202 may include an inertial system 206 and a drive system 208. The torsion system 202 may be mounted to the second structure 112. For example, referring to FIG. 2A, a housing 212 may be mounted to the second structure 112, and the drive system 208 may be mounted to the housing 212, although other configurations are contemplated, such as configurations in which the drive system 208 is mounted directly to the second structure 112. In examples, the housing 212 may be an electronics enclosure, a pressure vessel, or a different enclosure or vessel.

The inertial system 206 may be mounted to the drive system 208. For example, the inertial system 206 may include a float 218 and a weighted section 220. Referring to FIG. 2A, the float 218 and weighted section 220 may be connected to opposing ends of an arm 222. The arm 222 may be coupled to the drive system 208, such as at a portion between the float 218 and the weighted section 220. Referring to FIG. 2B, the float 218 may have a semicircle shape defining a cutout underneath in which the weighted section 220 is positioned. For example, the inertial system 206 may include a buoyant disk with a cutout on the bottom with the weighted section 220. In these and other configurations, the buoyancy of the float 218, and the opposing torque applied by the weighted section 220, may orient the inertial system 206 in a vertical orientation. The buoyancy of the truss 100 (e.g., a buoyancy characteristic) may be adjusted, such as prior to deployment or during deployment of the truss 100. For example, the buoyancy may be adjusted manually by adding or removing parts, adjusting the float 218 and/or weighted section 220, or the like. In other examples, the buoyancy may be adjusted automatically by the system (e.g., based on sensed conditions, orientation, etc.).

The drive system 208 may include a motor and a gearbox. In some examples, the drive system 208 may include buoyancy foam. Actuation of the motor may drive the gearbox to rotate. The inertial system 206 may resist the load applied by the motor, remaining vertical or substantially vertical as the gearbox rotates, thereby creating an anchor against rotation. As a result, the second structure 112 may rotate, such as in a first direction 226 to uncoil the coil 124 and expand the truss 100. Reversing the motor may rotate the second structure 112 in an opposite direction to retract the deployed truss 100, such as to collapse the truss 100 in the coil 124. In some examples, the torsion system 202 may be inactive for retraction, with retraction occurring by pulling the central deployment/retraction line 136, as described above.

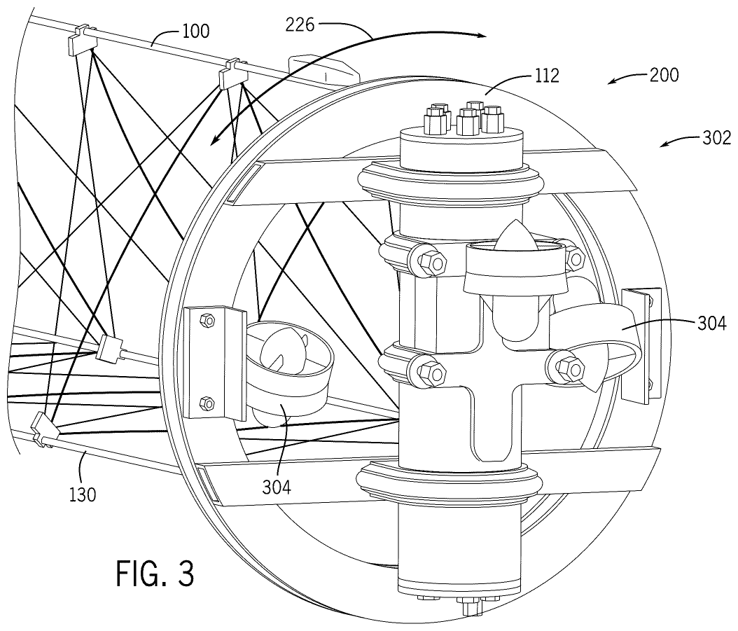

As another example, FIG. 3 illustrates the deployment system 200 as a thruster system 302. Like the torsion system 202, the thruster system 302 may allow controlled deployment of the truss 100, such as in the absence of fluid flow. The thruster system 302 may include at least one thruster 304 (e.g., multiple thrusters 304) coupled to the second structure 112. The thrusters 304 may be used to steer the deployment direction of the second structure 112, such as applying an axial load and/or a torsional load to extend the truss 100. For example, the thrusters 304 may induce torsion to rotate the second structure 112 in the first direction 226. The axial and/or torsional load may eject a fully deployed truss section 130 (e.g., a stiff truss section). In one example, the truss section 130 may be ejected or deployed in the wake of the leading coil 124. In another example, the truss section 130 may be ejected or deployed as the leading end. Reversing the thrusters 304 may rotate the second structure 112 in an opposite direction to retract the deployed truss 100, such as to collapse the truss 100 in the coil 124. In some examples, the thruster system 302 may be inactive for retraction, with retraction occurring by pulling the central deployment/retraction line 136, as described above.

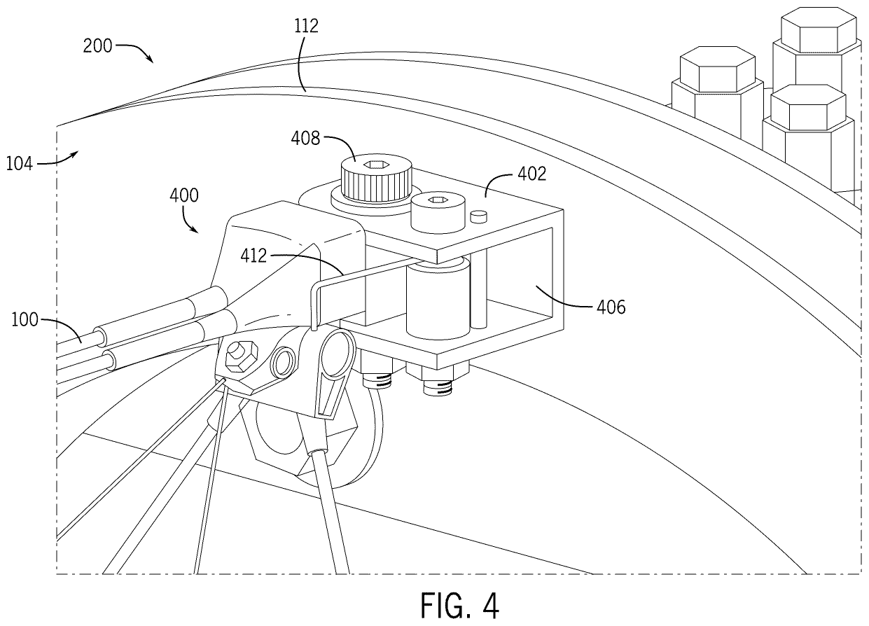

As another example of a deployment assistance feature, FIG. 4 illustrates a spring system 400 configured to bias the truss 100 to coil. In examples, the spring system 400 may be defined at the connection of the truss 100 to the second structure 112, such as to initiate or control deployment and/or recovery. For example, the spring system 400 may bias the truss 100 to coil at the second end 104 and/or deploy at the first end 102 first, rather than letting the truss 100 decide which end to coil or deploy. In other examples, the spring system 400 may be positioned or defined at other locations along the truss 100, such as at joints connecting truss sections together or other locations. The spring system 400 may include a joint 402 at the connection of the truss 100 to the first structure 108 and/or the second structure 112. The joint 402 may include a mount 406 defining a pivot 408. The truss 100 may be coupled to the mount 406 at the pivot 408, such as to allow the truss 100 to coil. One or more springs 412 may bias movement about the pivot 408. When connected to the first structure 108, the springs 412 may bias the first end 102 into the deployed shape, such as to bias the deployment of the truss 100 from the anchored first end 102. When connected to the second structure 112, the springs 412 may bias the second end 104 into the coiled shape, such as to prevent the second end 104 from deploying prematurely and/or biasing the second end 104 into the coiled shape. Additionally, or alternatively, the truss 100 may include other spring or elastic features configured to bias the truss 100 to the deployed configuration. For example, the truss 100 may be self-deployed with elastic stored energy, such as elastic energy stored in the longerons 114 when coiled (e.g., elastic energy in the longerons 114 biasing the truss 100 or coil 124 to uncoil).

Although described with reference to deploying the truss 100 in a horizontal or substantially horizontal orientation, the truss 100 may be deployed vertically or substantially vertically, or in a different orientation. In such examples, the method of deployment may remain the same (e.g., where the coil 124 leads, where the truss section 130 leads). When oriented vertically or substantially vertically, the controlled deployment may be aided by gravity, such as gravity pulling the coil 124 or truss section 130 downwards for truss deployment. In examples, the truss 100 may include a mass (e.g., at the leading end, such as the first end 102 or the second end 104) that facilitates deployment due to gravity. In other examples, the controlled deployment may be facilitated by buoyancy and/or drag mechanisms.

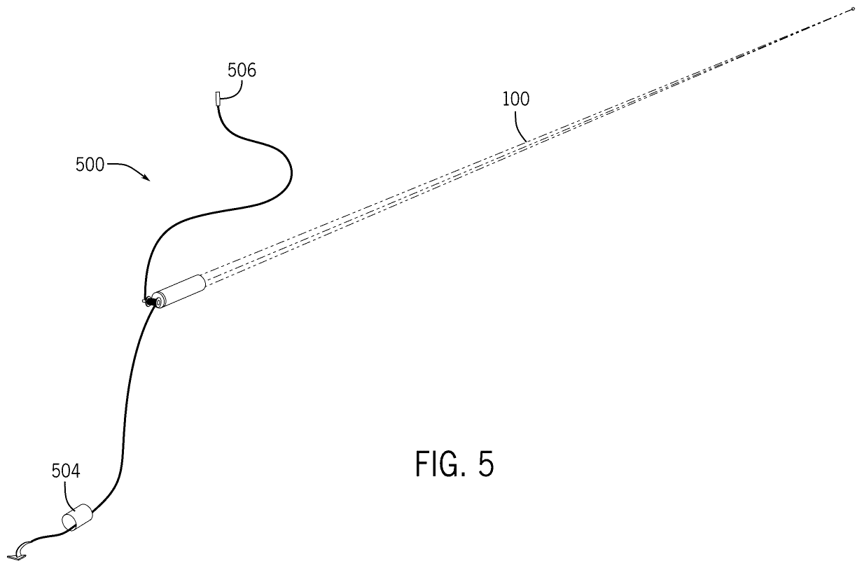

FIGS. 5-9 illustrate various examples of an orientation control system 500 for controlling an orientation of the truss 100 during deployment. The orientation control system 500 may be configured to adjust a position (e.g., vertical position) of the truss 100 within the water column. For example, the orientation control system 500 may be configured to adjust a vertical position of the leading, second end 104, or any midpoint along the truss 100, within the water column. In examples, the orientation control system 500 may be configured to control a relative altitude (e.g., a vertical position) of a free end of the truss 100 (e.g., the second end 104) relative to a stationary end of the truss 100 (e.g., the first end 102). As one example, FIG. 5 illustrates alignment of the system with the predominant current. The system may orient with the direction of the predominate current to allow the structure to be minimized. For example, external connections to the structure (e.g., an anchor connection 504 and a top surface connection 506) may be limited to a single point (e.g., at the fixed end, at the leading end), allowing the truss 100 to pivot about this point. In examples, the truss 100 may be set to remain within an angular threshold from the horizon, such as for orientation and positional awareness, sensor performance, to ensure entanglement risks are mitigated. In this manner, the truss 100 may swing with the tides and currents, easing deployment as the truss 100 is free to rotate to align with the horizon.

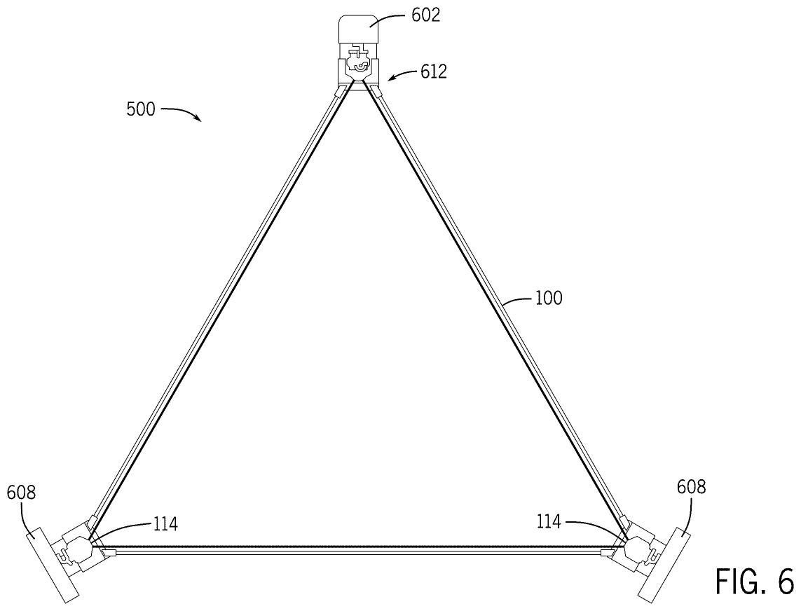

As another example of orientation control, FIG. 6 illustrates placement of buoyancy features to control an orientation of the truss 100. Specifically, buoyancy features may be strategically placed to control a vertical orientation (in cross-section) of the structure. For instance, positively buoyant items 602 (e.g., buoyancy nodes) may be positioned or coupled on an upper side of the truss 100, and negatively buoyant items 608 may be positioned or coupled on a lower side of the truss 100. As shown in FIG. 6, the positively buoyant items 602 may be at an upper apex 612, and the negatively buoyant items 608 may be at lower longerons 114 of the truss 100. Such configurations may allow the location of attached sensors (e.g. hydrophones) to be known, either alone or paired with orientation sensors. In some examples, the buoyant items 602 or 608 may include sensors, projectors, or another device (e.g., sensors 1900, described below). Any combination of the buoyant items 602 or 608 may be replaced with sensors, projectors, or a different device (e.g., sensors 1900). For example, the negatively buoyant items 608 may be replaced with sensors 1900.

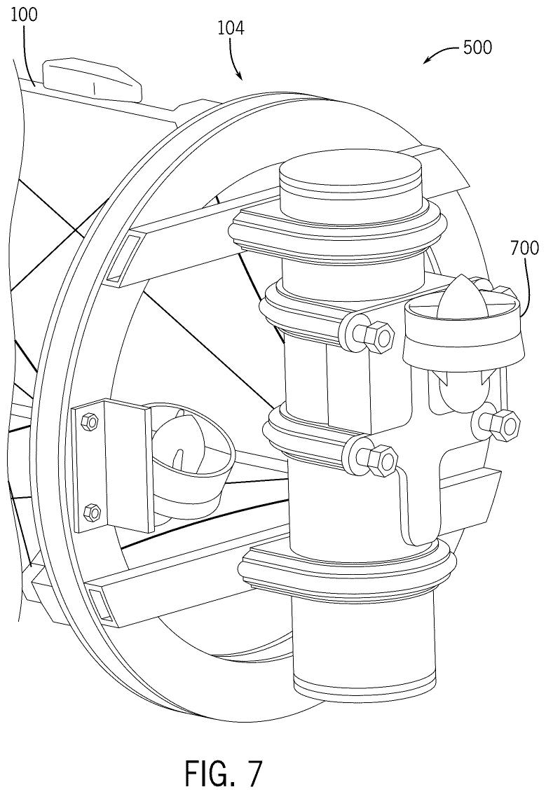

As other examples of orientation control, FIGS. 7-9 illustrate features to control an orientation of the truss 100 within the water column. Micro currents and variations in buoyancy can influence the orientation of the truss 100 within the water column. In such situations, it may be desirable to limit angular movement of the truss 100 relative to the horizon, such as to maintain sensor positioning, to limit entanglement with external features, to facilitate deployment and/or recovering, to adjust the incline of the truss 100, or for other reasons.

Referring to FIG. 7, the truss 100 may include an elevation control system 700. The elevation control system 700 may include one or more thrusters or propellers oriented vertically, such as attached to the second structure 112, a buoyancy engine, or other systems. When activated, the elevation control system 700 may induce a force at the second end 104 (e.g., a vertical force) to move the second end 104 up or down to a desired position, to maintain the second end 104 at a desired position (e.g., against rising or falling tides or currents), or the like, such as to maintain a horizontal orientation of the truss 100 within the water.

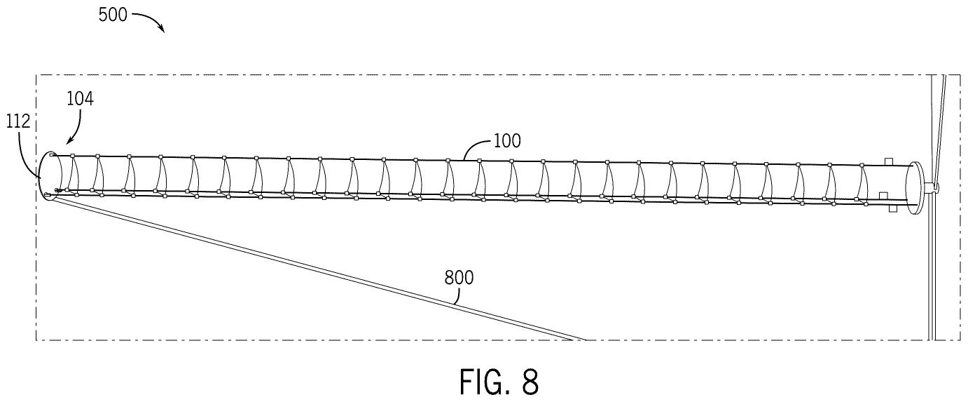

Referring to FIG. 8, the truss 100 may include a cable 800 extending from the second end 104 (e.g., the second structure 112) to an anchor (e.g., anchor connection 504). The cable 800 may be extended or retracted to define the position of the second end 104. For example, extending the cable 800 may allow the second end 104 to rise within the water column. Conversely, retracting the cable 800 may pull the second end 104 lower in the water column. In some examples, the length of the cable 800 may be fixed, such as based on the length of the truss 100, such that the cable 800 is taught at full extension of the truss 100. In such examples, the horizontal orientation of the truss 100 may be defined by the relative position of the anchor and the first end 102 (e.g., as defined by a right triangle shape).

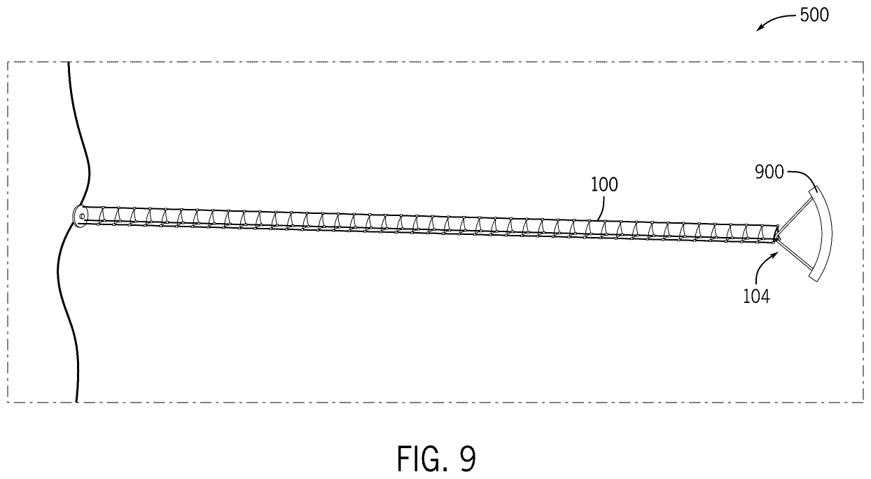

Referring to FIG. 9, the truss 100 may include a sea anchor or parachute 900 or other body to induce drag (hereinafter “sea anchor” for sake of convenience, without intent to limit). The sea anchor 900 may be attached to the second end 104 (e.g., the second structure 112). The sea anchor 900 may create drag against currents directed along the longitudinal length of the truss 100, inducing a force on the second end 104 that limits variations in the vertical positioning of the truss 100 in the water column.

FIGS. 7-9 illustrate only some examples of orientation control, and other configurations are contemplated. For instance, the truss 100 may include flaps, drogues, air bladders, or movable masses along the axial length of the truss 100, or any combination thereof, either alone or in combination with the features illustrated in FIGS. 7-9. Additionally, or alternatively, when deployed in a vertical orientation, a mass at the leading, second end 104 may keep the system oriented vertically, due to gravity, even when exposed to currents.

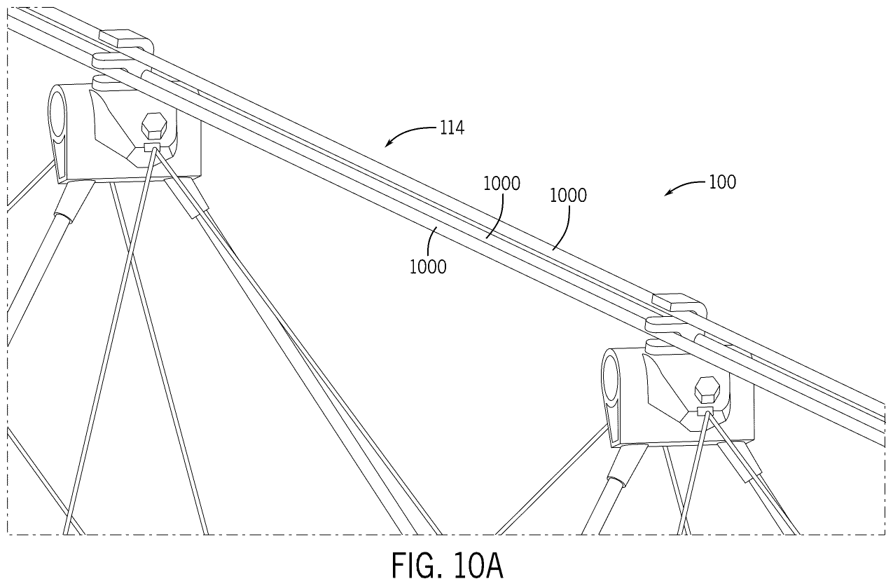

FIGS. 10A-10B illustrate example longeron configurations of the truss 100. Referring to FIG. 10A, a longeron 114 (e.g., each longeron 114) may include one or multiple rods 1000. The rods 1000 may be coupled to extend in a parallel relationship. For example, the longeron 114 may include three rods 1000 positioned to define apexes of a triangular shape (e.g., an equilateral triangle shape, a right triangle shape, an isosceles triangle shape, or a scalene triangle shape, among other shapes), although other multi-rod configurations are contemplated. For example, FIG. 10B illustrates another example longeron configuration with four rods 1000. Multiple, small diameter rods 1000, which may be referred to as longerons themselves, may provide numerous benefits over a single, larger diameter rod. For example, multiple rods 1000 may increase stored energy for deployment, allow the stowed diameter of the coil 124 to be minimized, provide design redundancy, or increase load carrying capacity, among other benefits. Multiple rods 1000 may improve stiffness while keeping coiling forces lower than an equivalent larger single rod.

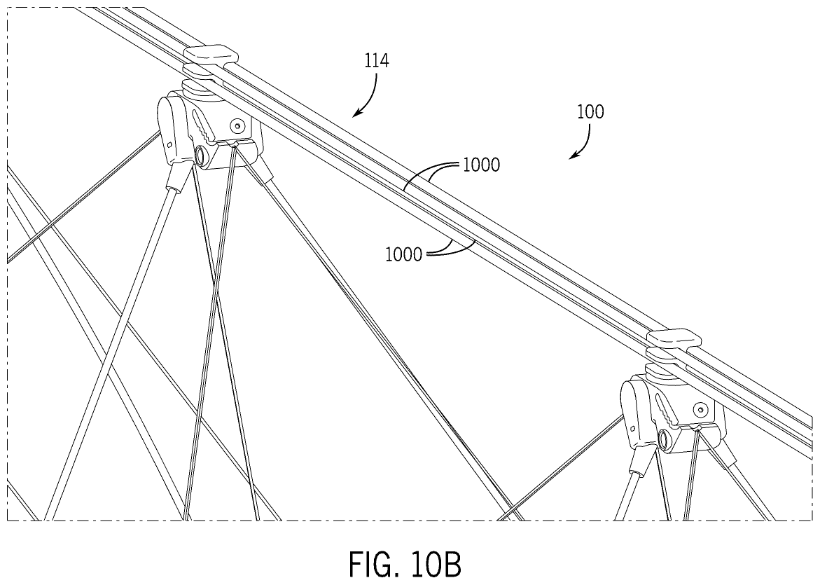

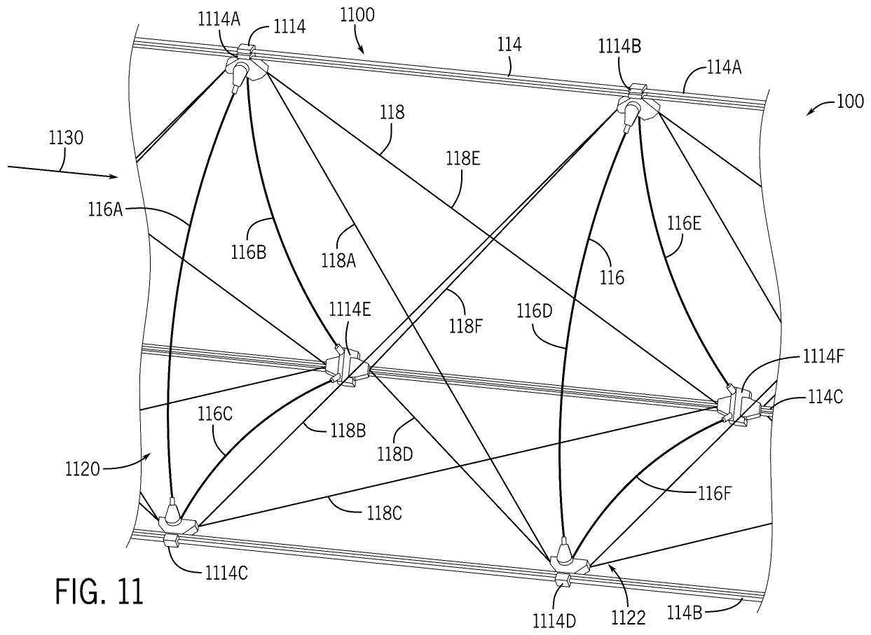

FIG. 11 illustrates an example bay 1100 of the truss 100 in an expanded configuration. The bay 1100 may be defined as a truss section, which is repeated continuously to define the length of the truss 100. For example, one bay 1100 may define a minimum length of the truss 100, two bays 1100 may define a second length of the truss 100, three bays 1100 may define a third length of the truss 100, and n bays 1100 may define an n length of the truss 100. Each bay 1100 may be self-supporting when expanded, such as defining a rigid truss section (or a portion of a rigid truss section) of the truss 100.

The bay 1100 may be defined by various structural elements, such as multiple longerons 114, battens 116, and diagonals 118. In the example of FIG. 11, the bay 1100 is defined by multiple joints 1114. For instance, first and second joints 1114A, 1114B may be connected to a first longeron 114A, third and fourth joints 1114C, 1114D may be connected to a second longeron 114B, and fifth and sixth joints 1114E, 1114F may be connected to a third longeron 114C. A first batten 116A may extend from the first joint 1114A to the third joint 1114C, a second batten 116B may extend from the first joint 1114A to the fifth joint 1114E, and a third batten 116C may extend from the third joint 1114C to the fifth joint 1114E. A fourth batten 116D may extend from the second joint 1114B to the fourth joint 1114D, a fifth batten 116E may extend from the second joint 1114B to the sixth joint 1114F, and a sixth batten 116F may extend from the fourth joint 1114D to the sixth joint 1114F.

The bay 1100 may include a first level 1120 and a second level 1122, with the second level 1122 spaced from the first level 1120 along the axial length of the truss 100. The first level 1120 may be defined by the first joint 1114A, third joint 1114C, fifth joint 1114E, first batten 116A, second batten 116B, and third batten 116C. The second level 1122 may be defined by the second joint 1114B, fourth joint 1114D, sixth joint 1114F, fourth batten 116D, fifth batten 116E, and sixth batten 116F.

One or multiple diagonals 118 may extend between the joints. For example, a first diagonal 118A may extend between the first joint 1114A and the fourth joint 1114D. A second diagonal 118B may extend between the second joint 1114B and the third joint 1114C. A third diagonal 118C may extend between the third joint 1114C and the sixth joint 1114F. A fourth diagonal 118D may extend between the fourth joint 1114D and the fifth joint 1114E. A fifth diagonal 118E may extend between the first joint 1114A and the sixth joint 1114F. A sixth diagonal 118F may extend between the second joint 1114B and the fifth joint 1114E. In examples, the diagonals 118 of each respective bay 1100 may be defined by a single piece of string or cord. For instance, a string or cord may run from the first joint 1114A to the fourth joint 1114D, from the fourth joint 1114D to the fifth joint 1114E, from the fifth joint 1114E to the second joint 1114B, from the second joint 1114B to the third joint 1114C, from the third joint 1114C to the sixth joint 1114F, and from the sixth joint 1114F back to the first joint 1114A to define the first diagonal 118A, fourth diagonal 118D, sixth diagonal 118F, second diagonal 118B, third diagonal 118C, and fifth diagonal 118E, respectively, although other configurations are contemplated. In other examples, the diagonals 118 may include other configurations. For example, the diagonals 118 may be rigid or semi-rigid, be made of solid rod, or the like.

The diagonals 118 may be tensioned to load the battens 116 in compressive load. For instance, the tensioning of the diagonals 118 may cause the battens 116 to bend along their lengths. Such configurations may allow the bay 1100 or truss 100 to hold its shape when expanded, among other benefits described herein. For example, the battens 116 may bow into a flow direction 1130 (e.g., the direction of fluid flow along the axial length of the truss 100), for the purposes described below.

FIG. 12 illustrates an example connection of adjacent diagonals 118 within the bay 1100. Adjacent diagonals 118 may be connected together, such as by an attachment 1200 at the intersection of adjacent diagonals 118. For instance, the attachment 1200 may be a knot, clip, or another connection. The first diagonal 118A and second diagonal 118B may be connected at their intersection by an attachment 1200 (e.g., a first attachment), the third diagonal 118C and fourth diagonal 118D may be connected at their intersection by another attachment 1200 (e.g., a second attachment), and the fifth diagonal 118E and sixth diagonal 118F may be connected at their intersection by another attachment 1200 (e.g., a third attachment).

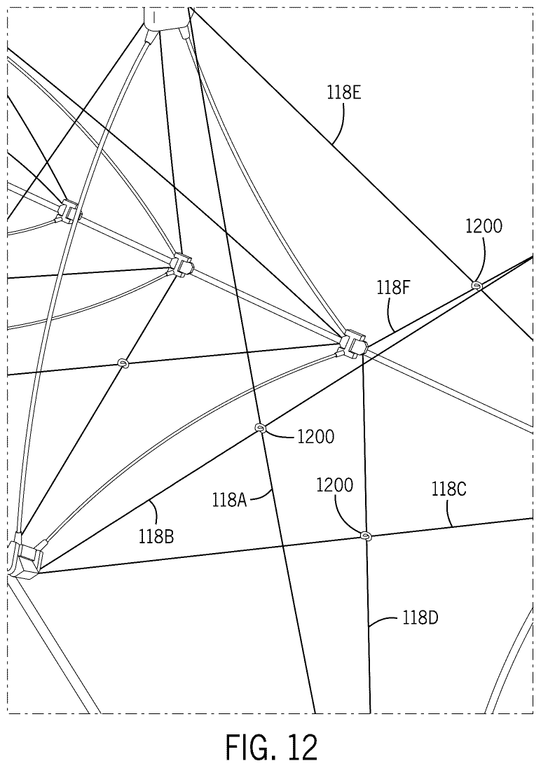

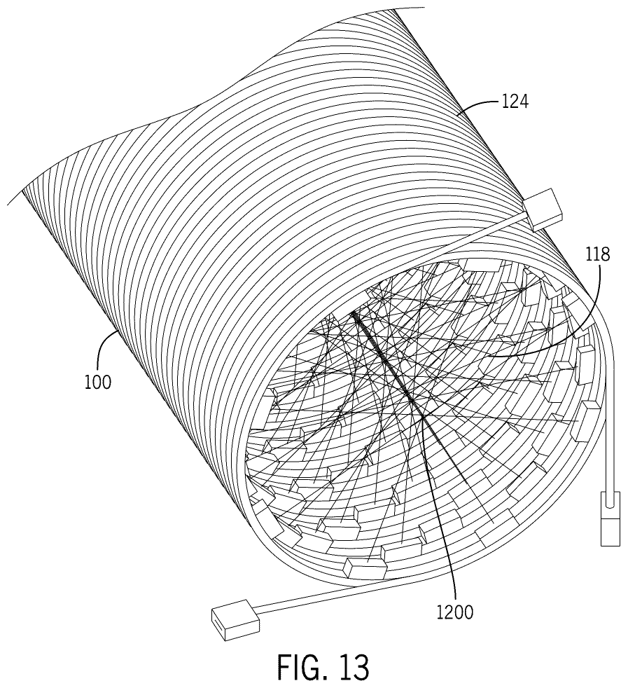

The attachments 1200 or connection of adjacent diagonals 118 may reduce the risk of entanglement during deployment. For instance, FIG. 13 illustrates the truss 100 in a collapsed configuration. When collapsed, the diagonals 118 may be constrained toward the inside diameter of the coil 124, reducing the diagonals 118 from tangling with the joints. In examples, the attachments 1200 may collocate at the center of the coil 124 in retraction.

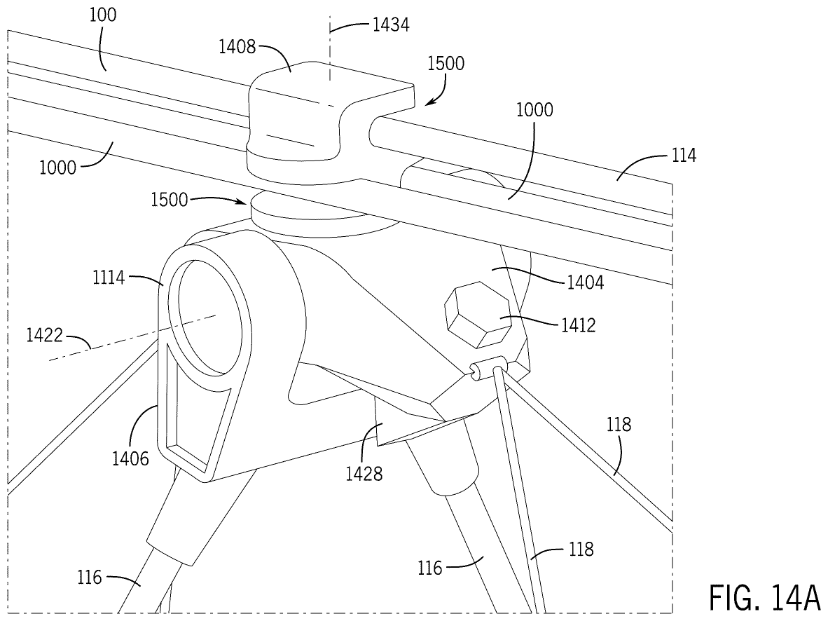

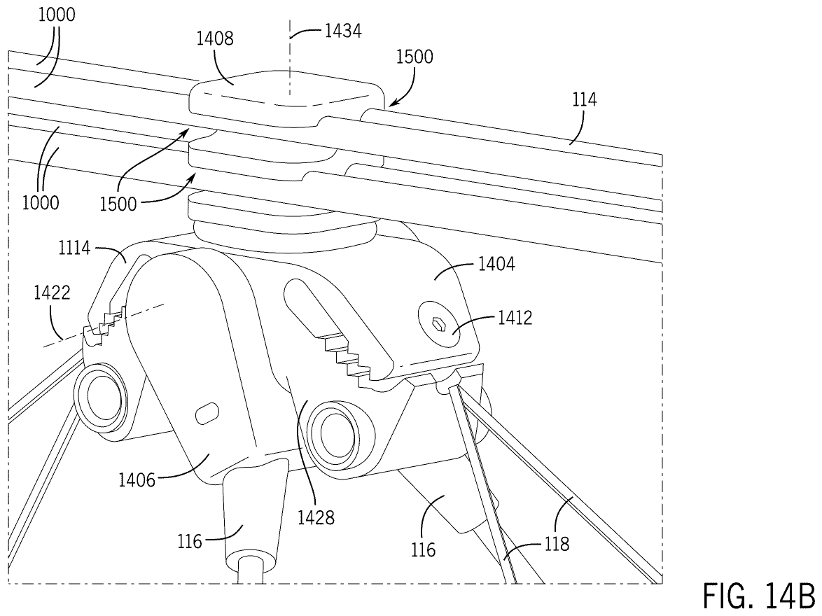

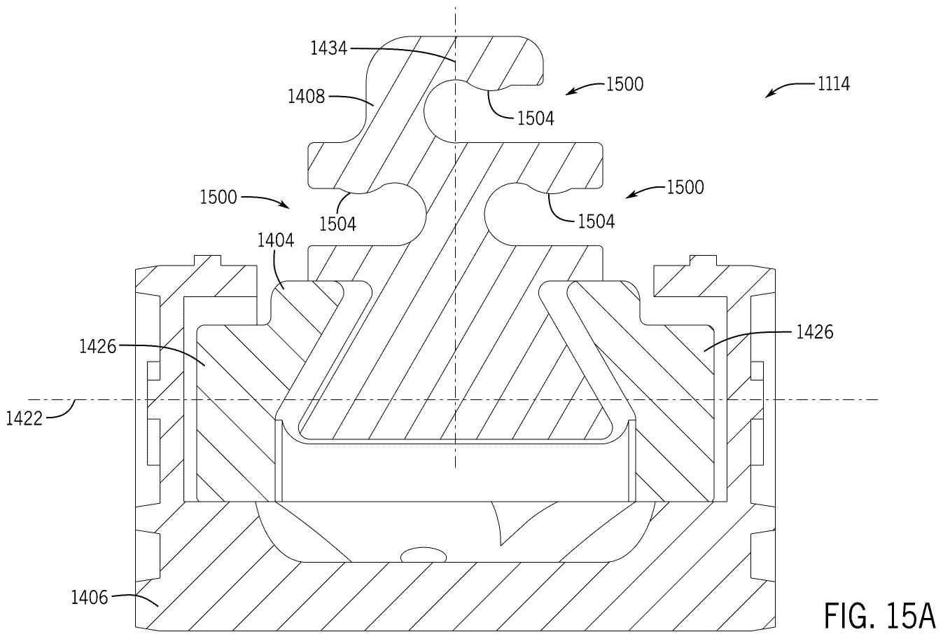

FIG. 14A illustrates an example joint 1114. FIG. 14B illustrates another example joint 1114. FIG. 15A illustrates a cross-sectional view of the joint 1114 of FIG. 14A. FIG. 15B illustrates a cross-sectional view of the joint 1114 of FIG. 14B. The joint 1114 may be a multibody assembly. For instance, the joint 1114 may include multiple parts that are manufactured (e.g., 3D printed) or assembled together. Such configurations may allow optimized geometries to be incorporated into the system, maximize system performance, and remove the need for assembly or post-processing that would be required if single body parts were used. In other examples, the multiple parts may be manufactured separately and assembled together as needed, such as for modularity.

The joint 1114 may include a platform 1404, a hinge 1406, and a connector 1408, or a combination thereof. The platform 1404 may include features for securing the diagonals 118. For instance, a fastener 1412 may secure the diagonals 118 against the platform 1404 (e.g., against ridges or other friction features defined on the platform 1404), although other configurations are contemplated.

The hinge 1406 may be rotatably coupled to the platform 1404, such as to rotate about a first axis 1422. In examples, the hinge 1406 may be rotatably coupled to a pair of bosses 1426 extending from the platform 1404. The hinge 1406 may rotate around the bosses 1426 to pivot about the first axis 1422, such as to allow the truss 100 to expand during deployment or collapse during retraction. In examples, the platform 1404 may include a stop 1428. Engagement of the hinge 1406 with the stop 1428 may define a configuration of the truss 100 or bay 1100. For instance, the hinge 1406 may rotate during deployment until the body of the hinge 1406 contacts the stop 1428. In this manner, the stop 1428 may limit rotation of the hinge 1406, such as to prevent the truss 100 from snapping into unstable orientations (e.g., during the coiling process). In examples, the battens 116 may be coupled to the hinge 1406, such as ends of the battens 116 attached to or received in the hinge 1406.

The connector 1408 may be rotatably coupled to the platform 1404, such as to rotate about a second axis 1434. The second axis 1434 may extend perpendicular to the first axis 1422. Rotation of the connector 1408 about the second axis 1434 may facilitate deployment and/or retraction of the truss 100. For example, rotation of the connector 1408 may allow relative movement between the longerons 114 and the joint 1114 for deployment and/or retraction. Rotation about the first axis 1422 and the second axis 1434 may provide the required range of motion while preventing motion that would prevent deployment and recovery.

As best illustrated in FIGS. 15A-15B, the connector 1408 may include grooves 1500 to receive the rods 1000 of the longeron 114. Each groove may include a detent 1504 to hold the rod 1000 in the groove 1500. For example, the detent 1504 may be a bump, ridge, or other feature protruding into the groove 1500. In such examples, the rods 1000 may be snapped into the grooves 1500, with the detents 1504 limiting removal of the rods 1000 once secured.

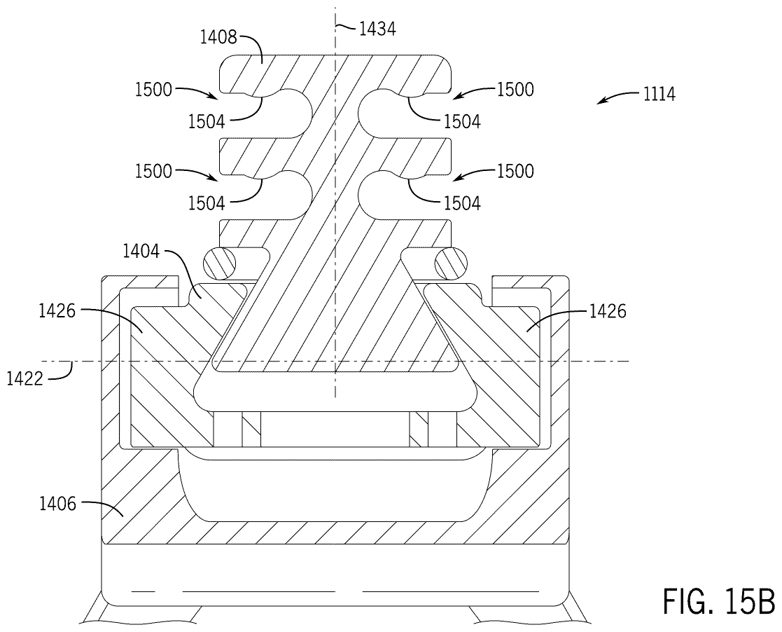

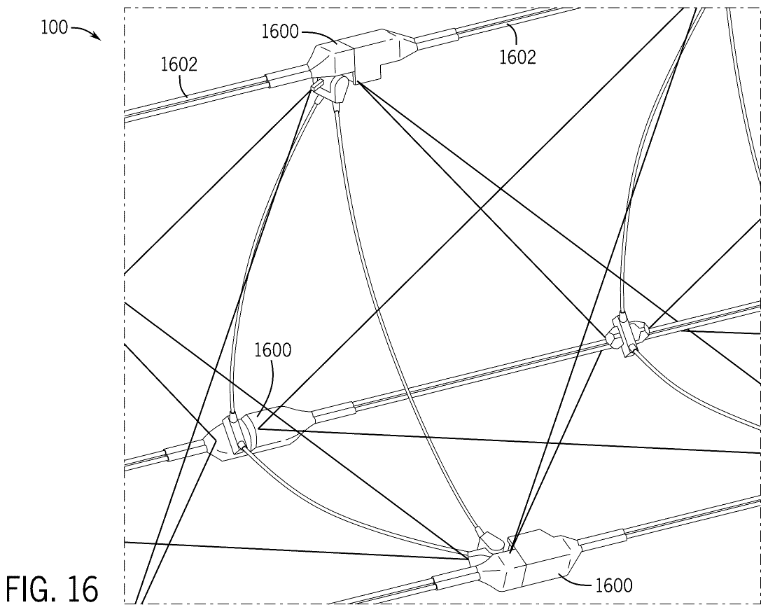

FIG. 16 illustrates an example connection joint 1600 for connecting separate truss units together. The connection joints 1600 may define nodes and support modularity in truss design or maintenance. For example, shorter base truss segments 1602 can be built to simplify the assembly process during manufacturing and remove the need for large or long rooms or complicated line assembly processes. The truss segments 1602 may be connected to one another via the connection joints 1600, such as to achieve a desired total system length. Additionally, or alternatively, damaged truss segments 1602 can be quickly, and easily, removed and replaced. Additionally, or alternatively, the stiffness and strength of each truss segment along the length of the truss 100 can be tailored, such as to compliment the requirements of systems with demanding loading conditions. For example, one truss segment 1602 may include a first stiffness or strength, and another truss segment 1602 may include a second stiffness or strength different than the first stiffness. The stiffness or strength of the truss segments 1602 may be determined by a number of rods 1000 per longeron 114, a stiffness of the rod(s) 1000, or the like. Additionally, or alternatively, multiple trusses 100 or truss segments 1602 in different orientations may be connected to a plurality of nodes or connection joints 1600 to form a volumetric array structure.

The connection joint 1600 may include a quick detach or attach mechanism. In some examples, the connection joint 1600 may include male and female components that couple together (e.g., via fasteners, corresponding engagement structures, etc.). Such configurations are exemplary only, and the connection joints 1600 may include other configurations allowing truss segments 1602 to be connected together.

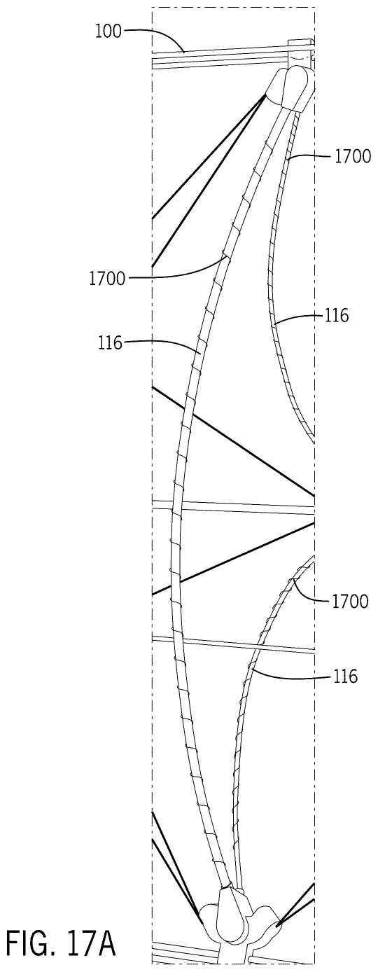

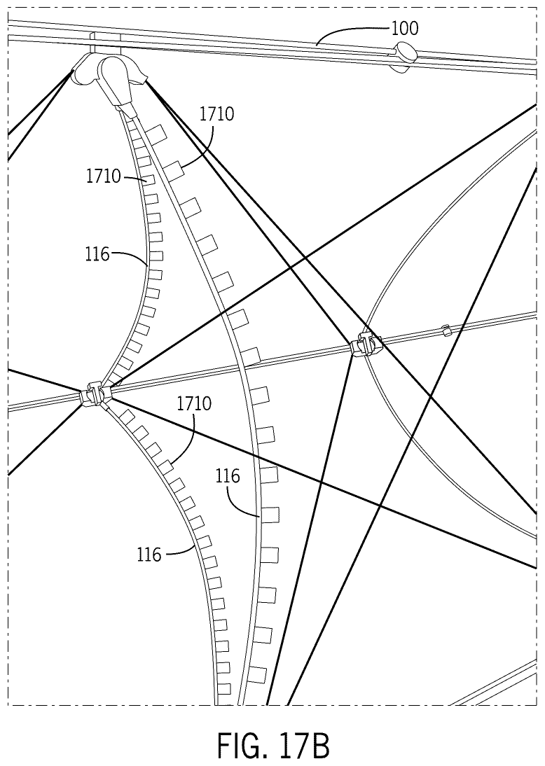

FIGS. 17A-17B illustrate example batten configurations of the truss 100. In examples, the battens 116 may include one or more features to reduce strum (e.g., a vibration of the battens 116 caused by fluid flow across the battens 116). Strum may induce unwanted vibrations in the system, which may adversely affect sensor sensitivity and readings, for instance. To reduce strum, the battens 116 may be set to bow into the direction of flow (e.g., the flow direction 1130). This increases the compressive loading in the battens 116 as the battens 116 tend to straighten, limiting the tendency of the battens 116 to vibrate.

To further reduce strum, one or more features may be added or defined by the battens 116. For example, referring to FIG. 17A, a helical wrap 1700 may be added to the battens 116. Referring to FIG. 17B, streamers 1710 may be added to the battens 116. In another example, the shape of the battens 116 themselves may reduce strum or otherwise shape fluid flow across the battens 116. For example, the battens 116 may be tear drop shaped, without intent to limit. The helical wrap 1700 and/or streamers 1710 may reduce the magnitude of strum and allow increased rates of flow before strum occurs.

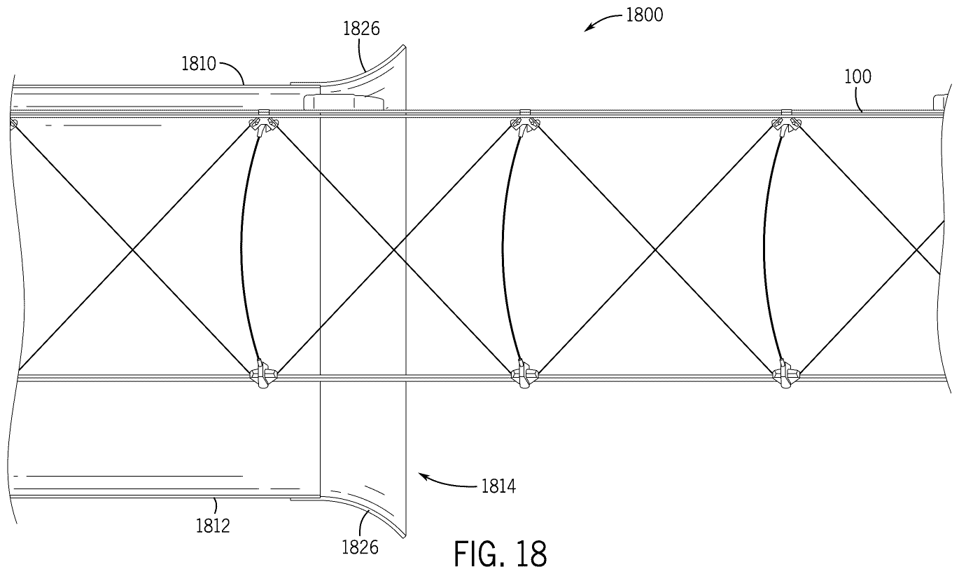

FIG. 18 illustrates example storage features of a truss system 1800. The truss system 1800 may include the truss 100 and a storage container or sleeve (hereinafter “storage unit” 1810 for sake of convenience without intent to limit). The storage unit 1810 may include a tubular body 1812 having an open end 1814. The tubular body 1812 may be sized to accommodate the truss 100 in a stored configuration. For instance, an inside diameter of the tubular body 1812 may accommodate the outside diameter of the coil 124 when collapsed.

In examples, the storage unit 1810 may have a geometry to guide the truss 100 into the unit for storage. As one example, the storage unit 1810 may be cone shaped or include a flute or ramp to guide the truss 100 into the stowed position. As another example, the storage unit 1810 may include guides 1826 (e.g., flanges, angles, chamfered edges, guiding features, or other transition element) at the open end 1814 of the tubular body 1812. The guides 1826 may be attached to the tubular body 1812, or the guides 1826 may be defined by the tubular body 1812 itself (e.g., flaring the open end 1814) to ease insertion of the truss 100 into, or deployment of the truss 100 from, the tubular body 1812. The guides 1826 may accommodate a large range in locations of the truss 100 from the axial centerline.

In some examples, the tubular body 1812 or outer housing may be a disposable item. For instance, the tubular body 1812 or outer housing may be designed to dissolve within the water column over time. In other examples, the tubular body 1812 or outer housing may be jettisoned after use (e.g., after deployment of the truss 100).

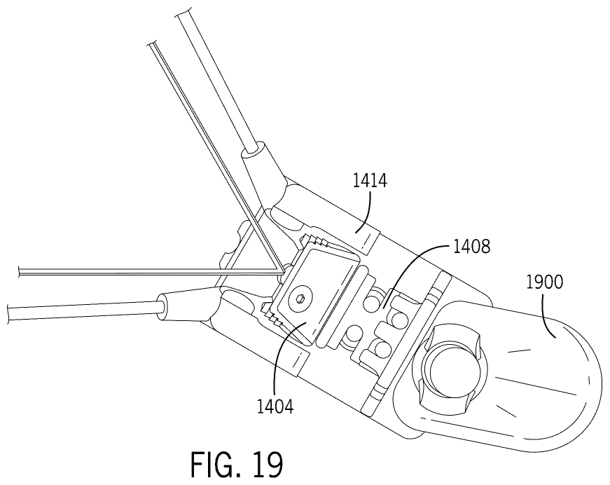

FIG. 19 illustrates an example sensor connection to the truss 100. In examples, the truss 100 may support or carry one or more (e.g., multiple) sensors 1900, such as to detect acoustic signals withing the water column. Depending on the application, the sensors 1900 may include hydrophones, pressure sensors, heading sensors, or temperature sensors, among other sensors The sensors 1900 may be connected to various components of the truss 100, such as based on sensor requirements, truss structure, etc. As one example, the sensors 1900 may be coupled at the joints 1114, such as strategically placed along the truss 100 at the joints 1114.

As shown in FIG. 19, the sensor 1900 may be coupled to the platform 1404 or connector 1408 of the joint 1114, such that the sensors 1900 are positioned on the outside diameter of the truss 100. The connection of the sensors 1900 to the joints 1114 may control the radial orientation of the sensors 1900 on the truss 100. For example, the connection may limit rotation of the sensors 1900 to the inner diameter of the truss 100 or coil 124 (e.g., the sensors 1900 fixed to the outer diameter of the truss 100 or coil 124, so as to not rotate to within the interior of the truss 100 or coil 124, etc.), thereby reducing risks of engagement, entanglement, or damage.

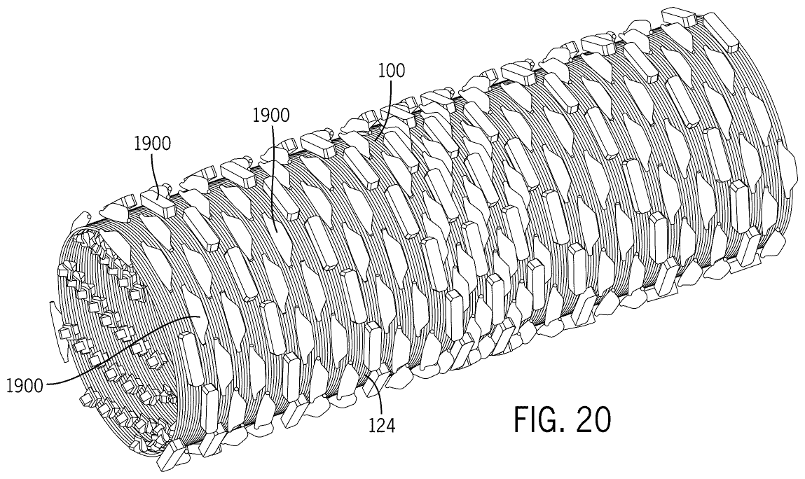

FIG. 20 illustrates an example sensor spacing that facilitates coiling of the truss 100. The sensors 1900 may be spaced along the truss 100 to allow the truss 100 to coil during retraction. For example, the sensors 1900 may be spaced so as to not overlap on the coil 124. The sensor spacing may be balanced between achieving a desired sensor array performance or characteristic, while ensuring that geometric interference is not experienced when the truss 100 is coiled. When deployed, the sensors 1900 may define a sensor array, such as a twin line array along the bottom of the truss 100 (e.g., positioned within a horizontal plane), although other configurations are contemplated.

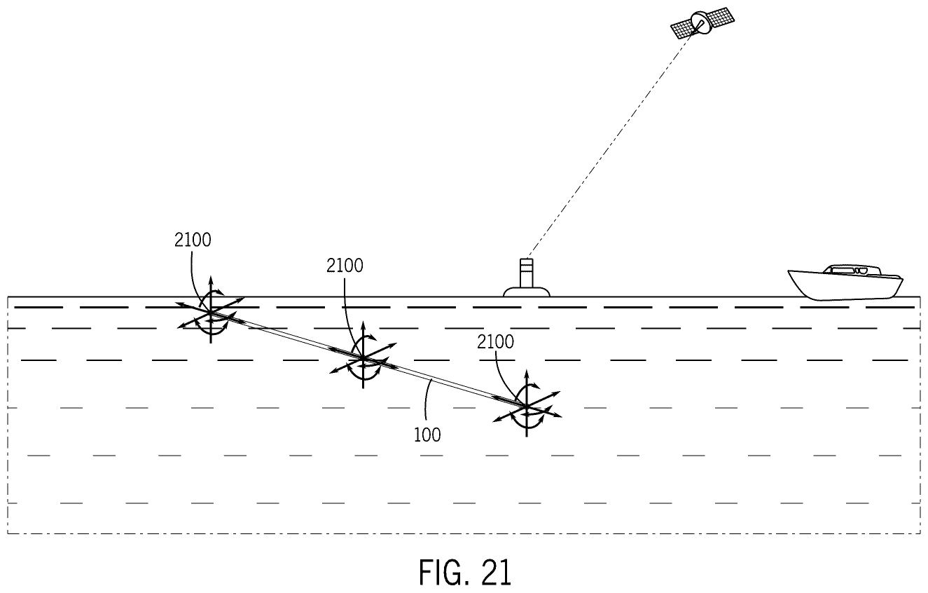

FIG. 21 illustrates an example sensor configuration of the truss 100. In examples, the truss 100 may include one or more sensors 2100 to determine a location and/or orientation of the truss 100. For instance, sensors such as roll, pressure, temperature, and compass may be used in conjunction with the known geometry of the truss 100 to determine its location and orientation within the water column. In examples, the sensors 2100 may communicate with satellite or ground-based sensor equipment (e.g., via communication equipment at the top surface connection 506) to determine the location of the truss 100.

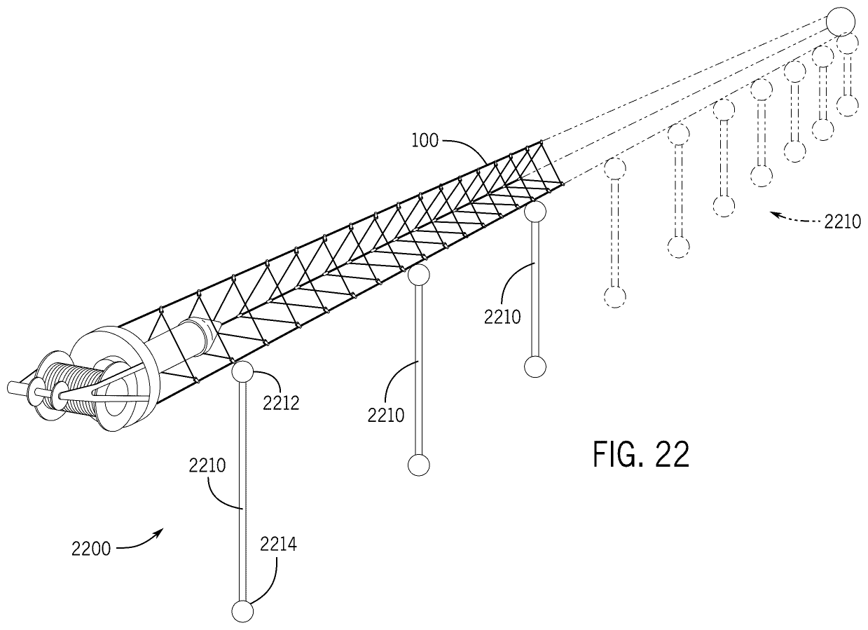

FIG. 22 illustrates an example sensor array of the truss 100. In embodiments, the truss 100 may be used for a planar array 2200. The planar array 2200 includes a plurality of sensors (e.g., sensors 1900 or alternative sensor systems) that are lowered from the truss 100. For example, line arrays 2210 may be distributed along the length of the truss 100. A line array 2210 may include a float 2212 at the top, and a weight 2214 at the bottom. The float 2212 and weight 2214 may ensure no vertical load is imposed on the truss 100, while ensuring the line array 2210 remains vertical in the water column.

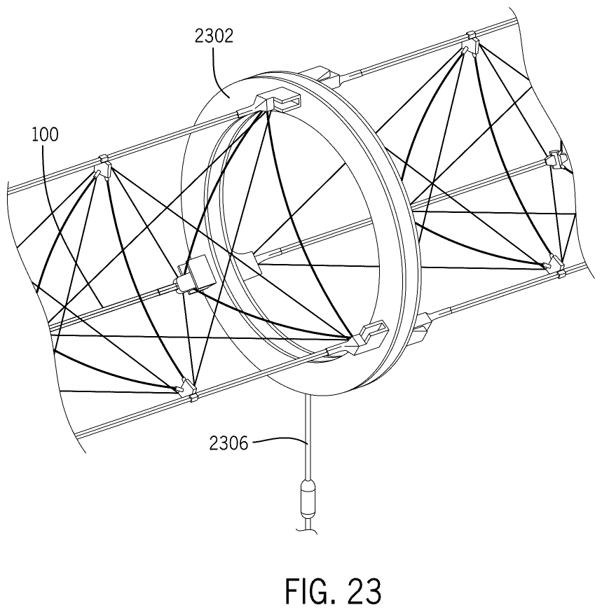

FIG. 23 illustrates an example system for deploying a sensor (e.g., the line array 2210) from the truss 100. As shown, the truss 100 may include a drum 2302 having a deployable line 2306. The drum 2302 may be rotated (e.g., by a winch) to selectively lower or raise the line and sensor (e.g., the line array 2210). For example, the drum 2302 may rotate to lower the line array 2210 to a desired depth below the truss 100. Conversely, reverse rotation of the drum 2302 may raise the line array 2210, such as to raise the line array 2210 in the water column or retract the line array 2210 completely. In this manner, the line array 2210 may be deployable via selective coiling of the deployable line 2306.

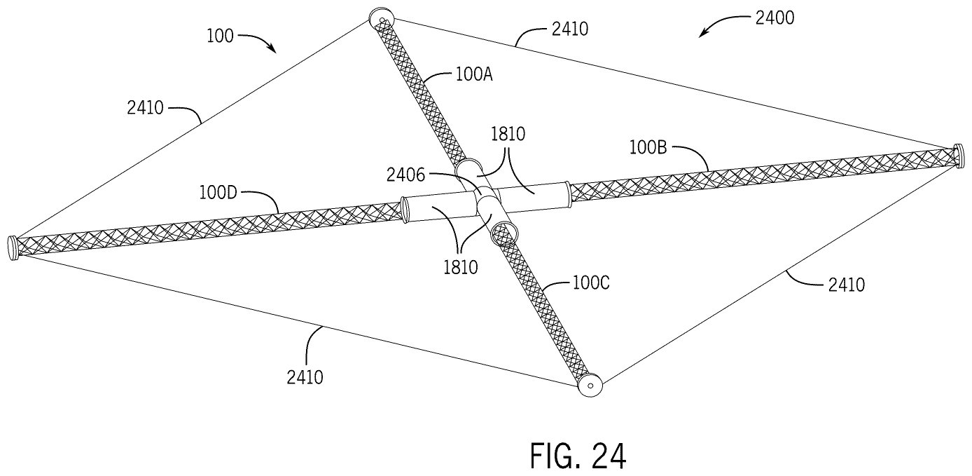

FIG. 24 illustrates an example volumetric array 2400. The volumetric array 2400 may be formed by a plurality of trusses 100 connected together. For example, the storage unit 1810 of each truss 100 in the volumetric array 2400 may be coupled together (e.g., end to end, to a central body or node 2406, a common coupling, etc.). The multiple trusses 100 may be similar, or the trusses 100 may include different characteristics (e.g., length, size, stiffness, strength, etc.). The multiple trusses 100 may extend outward from a central location defined at the coupling of the trusses 100. For example, the multiple trusses 100 may extend from the central node 2406 in different directions. In one example, the multiple trusses 100 may extend radially from the central node 2406. In another example, the multiple trusses 100 may extend in the same plane. In the example illustrated in FIG. 24, the volumetric array 2400 includes a first truss 100A, a second truss 100B, a third truss 100C, and a fourth truss 100D, although other configurations are contemplated. The first truss 100A may extend collinear with the third truss 100C. The second truss 100B may extend collinear with the fourth truss 100D. In some examples, the distal ends of the trusses 100 may be connected, such as by one or more cables 2410.

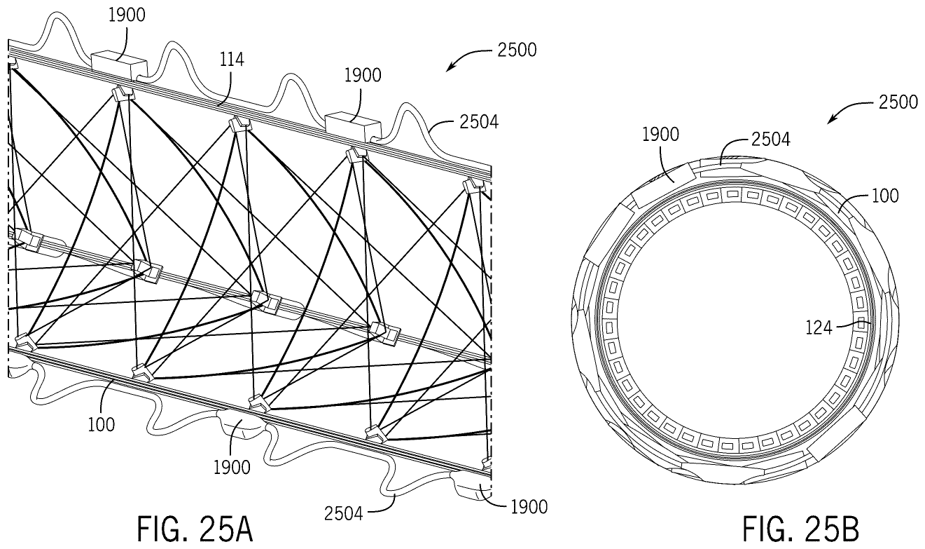

FIGS. 25A-25B illustrate an example cable management system 2500 for the truss 100. The cable management system 2500 may extend around or along the exterior of the truss 100. The cable management system 2500 may be configured to allow coiling of the truss 100 (see FIG. 25B). For example, one or more cables 2504 may extend along the longerons 114 for connecting the sensors 1900. The length of the cables 2504 between the sensors 1900 may be set based on the circumference of the coil 124 when the truss 100 is coiled. For example, as shown in FIG. 25A, the length of the cables 2504 between the sensors 1900 may be greater than the linear distance between the sensors 1900 to allow the truss 100 to coil. In one example, the length of the cables 2504 may be set equal to or greater than the circumference of the coil 124. In examples, the cable management system 2500 may be configured to limit positioning of the cables 2504 between adjacent coils of the coil 124 in the collapsed configuration (e.g., to avoid the cables 2504 falling in gaps, to reduce stowage ratio, etc.).

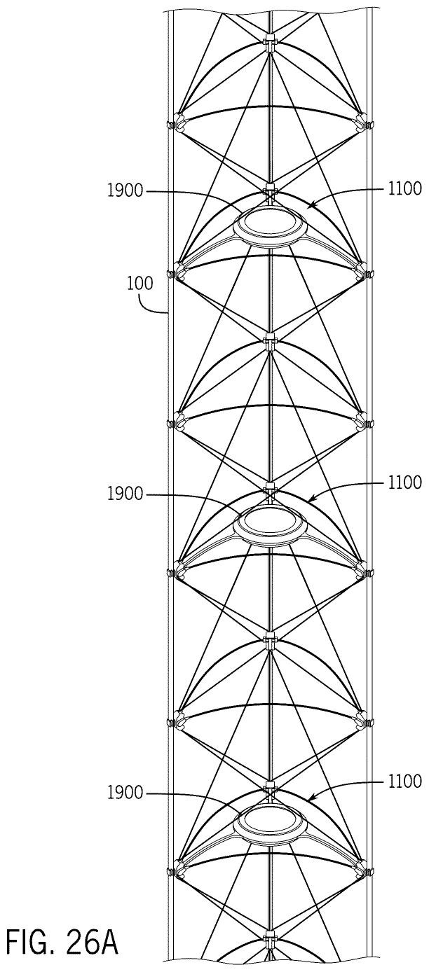

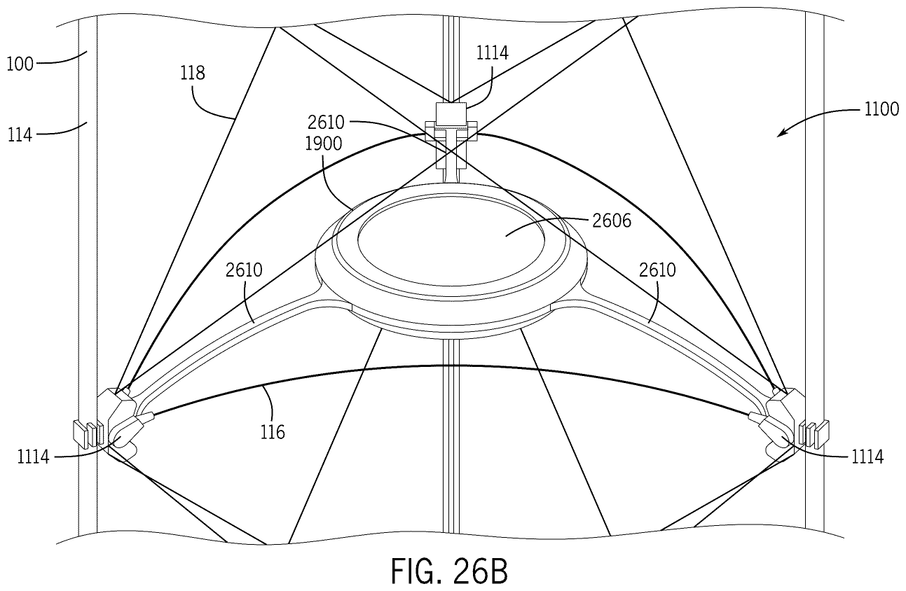

FIGS. 26A-26B illustrate an example sensor or projector configuration for the truss 100. The configuration illustrated in FIGS. 26A-26B may be oriented vertically or horizontally within the water column. The sensors 1900 may be located within the structure of the truss 100. For example, the sensors 1900 may be positioned within the inside diameter of the truss 100. In such examples, the sensors 1900 may include a body 2606 and one or more mounts or arms 2610 extending from the body 2606. The body 2606 may be defined by a disc-like structure or housing. The arms 2610 may extend to couple the sensor 1900 to the longerons 114, battens 116, diagonals 118, or another portion of the truss 100, or a combination thereof. In the example shown, the arms 2610 couple the sensor 1900 to one or more joints 1114, although other configurations are contemplated. In the illustrated example having three longerons 114, the sensor 1900 includes three arms 2610 for coupling the sensor 1900 to three joints 1114 defined at the same level of the truss 100.

The sensors 1900 may be positioned in an axial pattern along the length of the truss 100. The pattern can be every bay 1100 or every periodic number of bays 1100 (e.g., every other bay 1100, every third bay 1100, etc.). FIG. 26A illustrates the sensors 1900 located every two bays 1100 as an example. The sensors 1900 may be located centrally within the truss 100. For example, the sensors 1900 may be aligned collinearly along the center axis of the truss 100.

The arms 2610 or mounts may act in-tandem or replace the battens 116 in the truss 100 (at least at the level of the sensor 1900 within the truss 100). FIGS. 26A-26B show the arms 2610 working in-tandem with the battens 116. In one example, the arms 2610 may be resistant to deformation to hold the truss 100 in an expanded configuration. In another example, the arms 2610 may resiliently deform to allow the truss 100 to coil. When the truss 100 is coiled, the sensors 1900 may stack against one another, face to face. In another example, the sensors 1900 may stack adjacent one another, with a space maintained between adjacent sensors 1900.

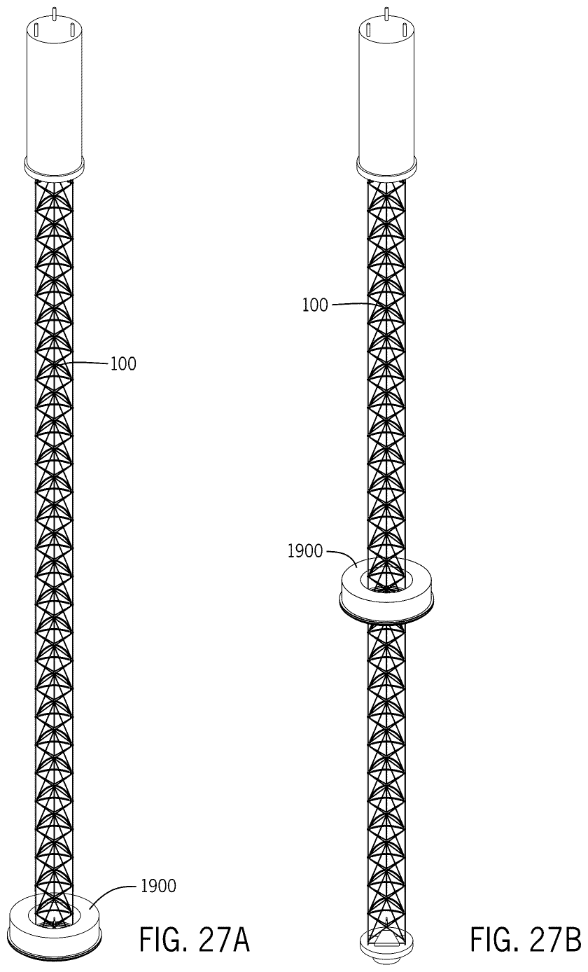

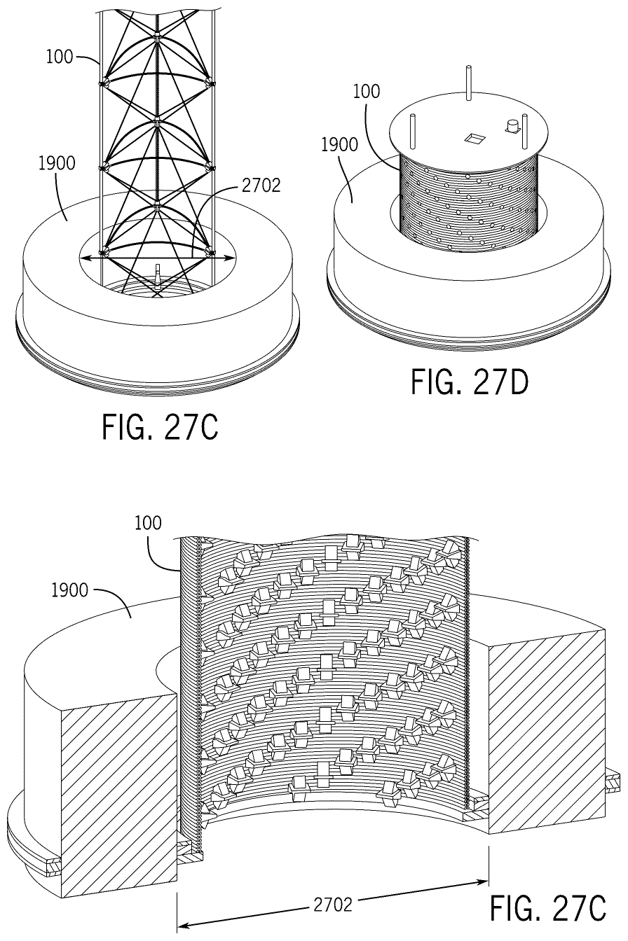

FIGS. 27A-27E illustrate another example sensor or projector configuration for the truss 100. The configuration illustrated in FIGS. 27A-27E may be intended to be mounted or deployed vertically within the water column. The truss 100 may include externally mounted sensors or projectors. For example, the sensors 1900 may extend around the outside diameter of the truss 100. In such configurations, the sensors 1900 may define a hollow cylinder having an inner diameter 2702. The truss 100 may fit within the inner diameter 2702 of the sensors 1900 when the truss 100 is expanded or collapsed. For example, the truss 100 may stow within the inner diameter 2702 of the sensor 1900.

The sensors 1900 may mount to the longerons 114, battens 116, diagonals 118, or another portion of the truss 100, or a combination thereof. In the example shown, the sensors 1900 mount to one or more joints 1114, such as the joints 1114 defined at a same level of the truss 100.

The sensors 1900 may be positioned in an axial pattern along the length of the truss 100. The pattern can be every bay 1100 or every periodic number of bays 1100. The pattern can be based on the length of the truss 100 (e.g., at the end, midway along the length, etc.). Referring to FIG. 27A, a sensor 1900 may be mounted at the bottom of the truss 100 (or the terminal end of the truss 100). When configured with a sensor 1900 at the bottom or terminal end of the truss 100, the deployment system 200 may be integrated with the design of the sensor 1900. Referring to FIG. 27B, a sensor 1900 may be mounted midway along the deployed length of the truss 100. In this manner, the truss 100 may include a single sensor 1900 or many sensors 1900 distributed as needed along the length of the truss 100.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A truss for deployment within a water column, the truss comprising:
a plurality of longerons connected together by a plurality of battens and a plurality of diagonals, the longerons resiliently deformable to form a coil when the truss is collapsed into a collapsed configuration;
a stationary end; and
a leading end configured to move away from the stationary end,
wherein, during deployment of the truss from the collapsed configuration, the coil sits at one of the stationary end or the leading end and a stiff truss section is ejected from the coil.

2. The truss of claim 1, wherein during deployment of the truss from the collapsed configuration, the coil sits at the leading end and moves away from the stationary end with the leading end to eject the stiff truss section in the wake of the coil.

3. The truss of claim 1, wherein during deployment of the truss from the collapsed configuration, the coil sits at the stationary end and rotates to eject the stiff truss section as the leading end.

4. The truss of claim 1, wherein at least one longeron of the plurality of longerons comprises four rods coupled together.

5. The truss of claim 1, further comprising:
a first structure at the stationary end;
a second structure at the leading end; and
at least one deployment/retraction line extending between the first structure and the second structure to control an axial speed of deployment or retraction of the coil.

6. The truss of claim 5, wherein the at least one deployment/retraction line is configured to sync a rotation of the coil with a deployment/recovery speed of the coil, and wherein the truss is configured to collapse into the coil when the deployment/retraction line is pulled.

7. The truss of claim 1, wherein the battens are bowed into a direction of current flow in the water column.

8. The truss of claim 1, wherein the battens comprise a helical wrap or streamers attached thereto.

9. The truss of claim 1, wherein:
the truss comprises a plurality of bays connected together in series to define a length of the truss; and
each bay comprises one or more diagonals extending along each side of the truss.

10. The truss of claim 9, wherein the one or more diagonals along each side of the truss are connected by an attachment at an intersection of the diagonals.

11. The truss of claim 1, further comprising a deployment system coupled to the leading end and configured to drive deployment of the truss, wherein the deployment system is configured to apply a torsional load to the coil to cause formation of the truss section from the coil.

12. The truss of claim 1, wherein the collapsed configuration creates elastic stored energy in the coil, and wherein the elastic stored energy is configured to self-deploy the truss from the collapsed configuration.

13. The truss of claim 1, wherein the truss is configured to deploy in a vertical orientation using a combination of gravity, buoyancy, and drag.

14. The truss of claim 1, further comprising an orientation control system configured to control an orientation of the truss, wherein the orientation control system is configured to adjust a vertical position of the truss within the water column.

15. A deployable truss comprising:
a plurality of longerons held together by a plurality of battens and a plurality of diagonals, the longerons resiliently deformable to form a coil in a collapsed configuration;
a leading end, the coil sitting at the leading end and configured to move with the leading end to deploy the truss; and
a deployment system coupled to the leading end and configured to drive deployment of the truss, wherein the deployment system is configured to apply a torsional load to the coil to cause formation of a rigid truss section in the wake of the leading coil.

16. The deployable truss of claim 15, wherein the deployment system comprises:
an inertial system; and
a drive system configured to rotate the leading end to uncoil the coil.

17. The deployable truss of claim 16, wherein the inertial system comprises a float and a weighted section, and wherein the inertial system is connected to the drive system at a portion between the float and the weighted section.

18. The deployable truss of claim 15, wherein the deployment system comprises at least one thruster coupled to the leading end, the least one thruster configured to induce a torsion to rotate the leading end to uncoil the coil.

19. The deployable truss of claim 18, wherein the at least one thruster is configured to apply an axial load to extend the truss.

20. A truss for deployment within a water column, the truss comprising:
a collapsible structure comprising a stationary end and a free end; and
an orientation control system configured to adjust a position of the truss within the water column, wherein the orientation control system is configured to control a vertical position of the free end relative to the stationary end.

21. The truss of claim 20, wherein the orientation control system comprises one or more thrusters configured to induce a force at the free end to move the free end up or down the water column.

22. The truss of claim 20, wherein the orientation control system comprises a cable coupled to the free end, and wherein adjustment of the cable adjusts a vertical position of the free end within the water column.

23. The truss of claim 20, wherein the orientation control system comprises a sea anchor or parachute coupled to the free end.

24. The truss of claim 20, wherein the orientation control system comprises a buoyancy characteristic, and wherein the buoyancy characteristic is adjustable prior to or during deployment of the truss.

25. A system comprising:
a truss comprising a collapsible structure defined by a plurality of longerons held together by a plurality of battens and a plurality of diagonals, the battens and diagonals connected to the longerons at joints, the collapsible structure resiliently deformable to form a coil in a collapsed configuration; and
a plurality of sensors coupled to the truss in a sensor spacing,
wherein the sensor spacing is configured to allow formation of the coil without geometric interference of the sensors.

26. The system of claim 25, wherein the sensors are connected to an outside diameter of the truss.

27. The system of claim 26, wherein a connection of the sensors to the truss limits a rotation of the sensors to an inner diameter of the coil.

28. The system of claim 25, wherein the sensors are positioned within the internal diameter of the truss.

29. The system of claim 28, wherein the sensors stack against one another, face to face, when the truss is collapsed to form the coil.

30. The system of claim 25, further comprising a cable management system around the exterior of the truss, the cable management system configured to limit positioning of one or more cables between adjacent coils of the coil in the collapsed configuration.
